(19) United States
(12) Patent Application Publication
(10) Pub. No.: US 2024/0180335 A1
(43) Pub. Date: Jun. 6, 2024

(54) OTTOMAN HAVING MASSAGE DEVICE

(71) Applicant: CERAGEM CO., LTD., Cheonan-si,Chungcheongnam-do (KR)

(72) Inventors: Dong Myoung Lee, Asan-si, Chungcheongnam-do (KR); Sang Ho Choi, Cheonan-si, Chungcheongnam-do (KR); Jin Cheol Park, Cheonan-si, Chungcheongnam-do (KR); Yong Seob Seo, Cheonan-si, Chungcheongnam-do (KR)

(21) Appl. No.: 18/283,766

(22) PCT Filed: Mar. 25, 2022
(86) PCT No.: PCT/KR2022/004221

§ 371 Date: Sep. 22, 2023

(30) Foreign Application Priority Data
Mar. 25, 2021 (KR) 10-2021-0039095

(51) Int. Cl. A47C 16/02; A61H 1/00; A61H 9/00; A61H 15/00

(52) U.S. Cl. CPC A47C 16/025; A61H 1/005; A61H 9/0078; A61H 15/0078; A61H 2201/0149; A61H 2201/0192; A61H 2201/5069; A61H 2201/5071; A61H 2205/12

(57) ABSTRACT

The present invention relates to an ottoman having a massaging apparatus. More specifically, the present invention relates to an ottoman having a massaging apparatus, the ottoman being usable as an ottoman enabling a part of the physical body of a user, sitting on a chair, to be conveniently put thereon at normal times, and being capable of conveniently massaging, if necessary, a part of the physical body of the user sitting on a chair.

### TECHNICAL FIELD

The present invention relates to an ottoman having a massaging apparatus. More specifically, the present invention relates to an ottoman having a massaging apparatus, the ottoman being usable as an ottoman enabling a part of the physical body of a user, sitting on a chair, to be conveniently put thereon at normal times, and being capable of conveniently massaging, if necessary, a part of the physical body of the user sitting on a chair.

### BACKGROUND TECHNOLOGY

In general, an ottoman, a type of furniture, is used to comfortably place one's legs while sitting on a chair, etc. These ottomans are typically sold together with the chair or purchased and used separately from the chair.

In order for a user to massage their legs using this ottoman, they place a separately provided leg massager on top of the ottoman, and when used in this way, since the leg massager is placed on an ottoman that has a certain height, there was a problem in that the user's legs are placed too high and the user feels uncomfortable during the leg massage process.

In the case of conventional massage chairs, leg massagers for massaging the user's legs are provided together, but the leg massagers provided in massage chairs cannot be used as an ottoman function, and are not suitable for using only leg massagers sitting in furniture such as chairs, and since massage chairs are expensive products, there is a limitation in that they are not suitable for purchasing them for the purpose of ottoman function or leg massage.

Therefore, there is a need to develop technology that can be used as an ottoman in normal times and can massage the user's legs when necessary.
(Patent Document 1) Korean Laid-Open Patent Publication No. 2006-0010815 (published 2006 Feb. 2)

### SUMMARY OF THE INVENTION

### Technical Tasks

The technical problem to be solved by the present invention is to solve the problems of the related art described above, and is directed to providing an ottoman having a massaging apparatus, the ottoman being usable as an ottoman enabling a part of the physical body of a user, sitting on a chair, to be conveniently put thereon at normal times, and being capable of conveniently massaging, if necessary, a part of the physical body of the user sitting on a chair.

The technical problems to be solved in the present invention are not limited thereto, and other technical problems not mentioned will be clearly understood by those of ordinary skill in the art from the following description.

### Technical Solution

The ottoman having a massaging apparatus according to the present invention for solving the above problems may include a main body unit having a massage member that massages a part of a physical body of a user; a support unit provided on the bottom surface of the main body unit to adjust a height of the main body unit away from the ground; a cover unit surrounding the top surface of the main body unit; and a control unit for controlling the operations of the main body unit and the support unit.

In this case, the ottoman having a massaging apparatus may further include a first detection unit that detects that the cover unit is separated from the main body unit.

In this case, the first detection unit may be disposed on at least one of the top surface of the main body unit or the bottom surface of the cover unit.

In this case, an outer support surface spaced apart from the ground by a first height to support a part of the user's physical body may be provided on the top surface of the cover unit, the main body unit may be provided with an accommodating groove into which a part of the user's physical body is inserted and which is provided with an inner support surface spaced apart from the ground by a second height, and the control unit may control the operation of the support unit so that the inner support surface moves up to the first height when a separation signal of the cover unit is input from the first detection unit.

In this case, the ottoman having a massaging apparatus may further include an input unit for inputting the first height or the second height desired by the user, and the control unit may control the operation of the support unit to correspond to the first height or the second height input through the input unit.

In this case, the control unit may be provided with a storage member that stores a height value input through the input unit.

In this case, the control unit may control the operation of the massage member or the support unit according to a signal input through the input unit.

In this case, the control unit may control the operation of the massage member when a separation signal of the cover unit is input from the first detection unit.

In this case, the ottoman having a massaging apparatus may further include a second detection unit that detects that a part of the user's physical body is inserted into the main body unit.

In this case, an outer support surface spaced apart from the ground by a first height to support a part of the user's physical body may be provided on the top surface of the cover unit, the main body unit may be provided with an accommodating groove into which a part of the user's physical body is inserted and which is provided with an inner support surface spaced apart from the ground by a second height, and the control unit may control the operation of the support unit so that the inner support surface moves up to the first height when a signal that a part of the user's physical body is inserted is input from the second detection unit.

In this case, the second detection unit may detect pressure applied by the massage member to a part of the user's physical body, and the control unit may control the operation of the support unit when a pressure signal that a part of the user's physical body is pressurized is input from the second detection unit.

In this case, the control unit may control the operation of the support unit when a signal is input from a support module that supports another physical body part of the user.

In this case, the control unit may control the operation of the support unit when a tilt angle signal of a lower plate member that is provided in the support module and supports the user's buttocks is input.

In this case, the control unit may control the operation of the support unit so that a separation height of the main body unit increases when the tilt angle of the lower plate member increases, and may control the operation of the support unit so that the separation height of the main body unit decreases when the tilt angle of the lower plate member decreases.

In this case, the massage member may be one of an air pocket that pressurizes a part of the user's physical body using air pressure, a pressure roller that applies acupressure to a part of the user's physical body, and a vibrator that applies vibration to a part of the user's physical body.

In this case, a height lever may be provided on one side of the main body unit to manually adjust the height at which the main body unit is separated from the ground, and a tilting lever may be provided on the other side of the main body unit to manually adjust the tilt angle of the main body unit so that the main body unit is disposed at an angle to the ground.

### Advantageous Effects

In the ottoman having a massaging apparatus of the present invention having the above configuration, the massage member is provided in the main body unit to massage parts of the user's physical body, and the support unit is configured to adjust the height of the main body unit, so that user convenience is improved by adjusting the height of the main body unit according to the usage condition, and in particular, the cover unit is provided on the upper portion of the main body unit, so it can be used as an ottoman on which a part of the user's physical body can be placed, and the control unit is provided to automatically control the operations of the main body unit and the support unit, thereby improving user convenience.

In addition, when the massage function is used to massage a part of the physical body by separating the cover unit, it is configured so that the height of the main body unit is automatically adjusted and the user can input the height of the main body unit, thereby improving user convenience.

Furthermore, the height of the main body unit is automatically adjusted in linkage with the support module that supports other physical body parts of the user, thereby improving user convenience.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a side view of an ottoman having a massaging apparatus according to an embodiment of the present invention.

FIG. 2 is a front view of an ottoman having a massaging apparatus according to an embodiment of the present invention.

FIG. 3 is a side view showing a state in which a cover unit of an ottoman having a massaging apparatus according to an embodiment of the present invention is being separated.

FIG. 4 is a front view showing a state in which a cover unit of an ottoman having a massaging apparatus according to an embodiment of the present invention is being separated.

FIG. 5 is a front view showing a state in which the height of a main body unit is adjusted in a state in which a cover unit of an ottoman having a massaging apparatus according to an embodiment of the present invention is separated.

FIG. 6 is a front view showing a state in which the height of a main body unit is adjusted in a state in which a cover unit of an ottoman having a massaging apparatus according to another embodiment of the present invention is separated.

FIGS. 7 and 8 are side views showing a state in which an ottoman having a massaging apparatus according to an embodiment of the present invention is used with a support module for supporting other parts of the user's physical body, and are side views showing a state in which the height of the main body unit is adjusted in linkage according to the arrangement of the support module.

FIG. 9 is a cross-sectional view showing a massage member according to various embodiments of the present invention.

### DETAILED DESCRIPTION OF THE EMBODIMENTS

Hereinafter, embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention. Throughout the specification, like reference numerals denote like elements.

It is understood that the terms “comprise” or “have” when used in this specification, are intended to specify the presence of stated features, integers, steps, operations, elements, components and/or a combination thereof but not preclude the possibility of the presence or addition of one or more other features, integers, steps, operations, elements, components, or a combination thereof. In addition, it will be understood that when an element such as a layer, film, region, or plate is referred to as being “on” another element, it can be “directly on” the other element or intervening elements may also be present. Conversely, it will be understood that when an element such as a layer, film, region, or plate is referred to as being “below” another element, it can be “directly below” the other element or intervening elements may also be present.

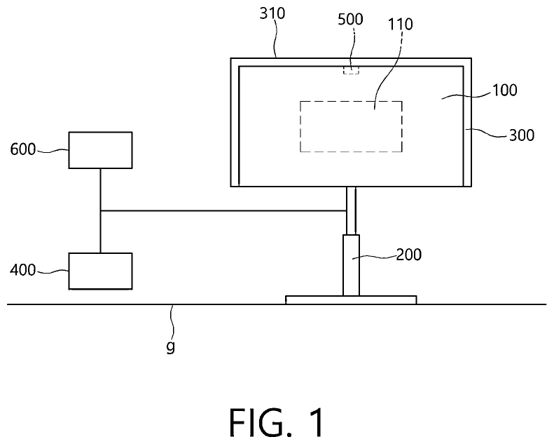

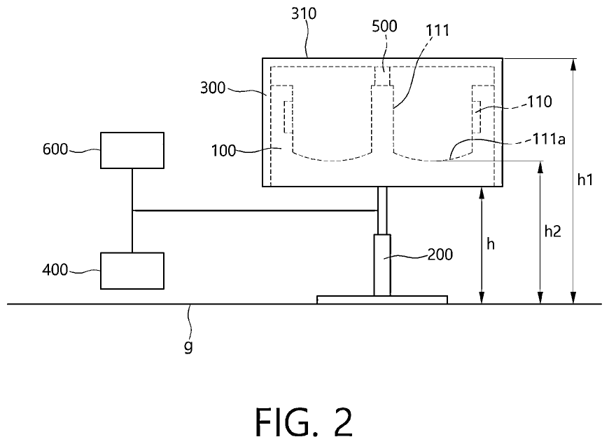

FIG. 1 is a side view of an ottoman having a massaging apparatus according to an embodiment of the present invention, and FIG. 2 is a front view of an ottoman having a massaging apparatus according to an embodiment of the present invention.

As shown in FIGS. 1 and 2, the ottoman having a massaging apparatus according to the present invention may include a main body unit 100 having a massage member 110 that massages a part of the physical body of the user, a support unit 200 provided on the bottom surface of the main body unit 100 to adjust the height h of the main body unit 100 away from the ground g, a cover unit 300 surrounding the top surface of the main body unit 100, and a control unit 400 for controlling the operations of the main body unit 100 and the support unit 200.

The main body unit 100 is provided with a massage member 110 to massage parts of the user's physical body. As an example, the user can perform a leg massage by placing his or her legs on the main body unit 100 or perform a foot massage by placing his or her feet while sitting on a separate piece of furniture, such as a chair.

The support unit 200 is provided on the bottom surface of the main body unit 100, and the support unit 200 adjusts the height h of the main body unit 100 so that the main body unit 100 is spaced apart from the ground g. That is, the support unit 200 adjusts the height h of the main body unit 100 to a height h that allows the user to comfortably place his or her legs or feet and receive a massage while sitting on a chair, etc. The support unit 200 may be provided with an antenna-type or bellows-type case, and various mechanisms for adjusting the height of the main body unit 100 may be provided inside such a case. For example, a height adjustment member of a ball screw structure, a height adjustment member using a hydraulic cylinder, a jack type or lead screw type height adjustment member, a gas lifting type height adjustment member, etc. may be provided. A height lever for operating the height adjustment member may be provided on one side of the main body unit 100. In this case, the support unit 200 may be provided with a tilt angle adjustment member that adjusts the tilt angle of the main body unit 100. That is, the main body unit 100 is adjusted to be tilted at a certain angle with the ground g using the tilt angle adjustment member. As an example, it can be configured to adjust to form a tilt of approximately 22.5 degrees forward toward the user, or to form a tilt of approximately 22.5 degrees backward in the opposite direction. To this end, the tilt angle adjustment member may be configured to have a tilt angle adjustment range of approximately 45 degrees. A tilting lever for operating the tilt angle adjustment member may be provided on the other side of the main body unit 100. The user can adjust the tilt angle of the main body unit 100 by pulling the tilting lever, and when the tilting lever is released while the tilt angle of the main body unit 100 is adjusted, the tilt angle of the main body unit 100 is fixed.

In addition, the cover unit 300 is provided on the top surface of the main body unit 100 to surround the main body unit 100, and with the cover unit 300 mounted in this way, the user may place a part of the physical body on the cover unit 300 and use it as an ottoman. This cover unit 300 may be made of a synthetic resin material having elasticity and rigidity.

In addition, the control unit 400 controls the operations of the main body unit 100 and the support unit 200. That is, user convenience can be improved if the control unit 400 is configured to automatically control the operation of the massage member 110 provided in the main body unit 100 or the operation of the height adjustment member provided in the support unit 200.

As described above, the massage member 110 is provided in the main body unit 100 to massage parts of the user's physical body, and the support unit 200 is configured to adjust the height h of the main body unit 100, so that user convenience is improved by adjusting the height h of the main body unit 100 according to the usage condition, and in particular, the cover unit 300 is provided on the upper portion of the main body unit 100, so it can be used as an ottoman on which a part of the user's physical body can be placed, and the control unit 400 is provided to automatically control the operations of the main body unit 100 and the support unit 200, thereby improving user convenience.

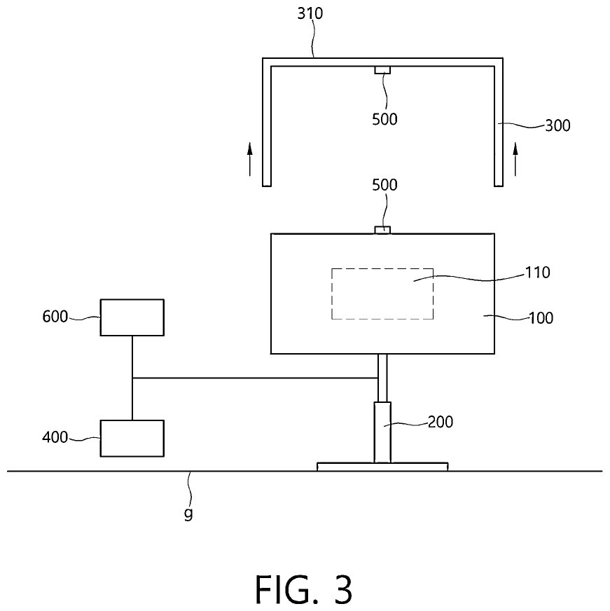

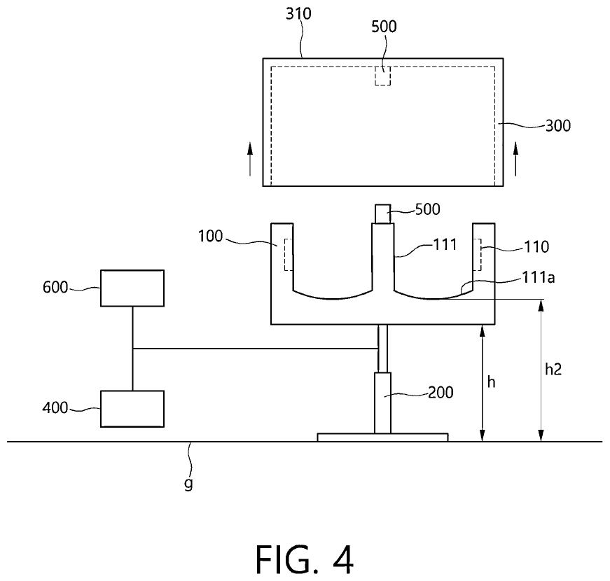

FIG. 3 is a side view showing a state in which a cover unit of an ottoman having a massaging apparatus according to an embodiment of the present invention is being separated, and FIG. 4 is a front view showing a state in which a cover part of an ottoman having a massaging apparatus according to an embodiment of the present invention is being separated.

As shown in FIGS. 3 and 4, a first detection unit 500 that detects that the cover unit 300 is separated from the main body unit 100 may be further included. The user separates the cover unit 300 to use the massage member 110 provided in the main body unit 100, the first detection unit 500 detects that the cover unit 300 is separated from the main body unit 100 during the process of separating the cover unit 300, and through this, the control unit 400 controls the operation of the massage member 110 provided in the main body unit 100 or the operation of the height adjustment member provided in the support unit 200.

This first detection unit 500 may be disposed on at least one of the top surface of the main body unit 100 or the bottom surface of the cover unit 300. As an example, the first detection unit 500 may use a switch-type detection sensor, and when the first detection unit 500 is disposed on the top surface of the main body unit 100 or on the bottom surface of the cover unit 300, a switch is pressed as the cover unit 300 is mounted on the top surface of the main body unit 100, and in the process that the cover unit 300 is separated from the main body unit 100, the separation of the cover unit 300 from the main body unit 100 is detected by using the release of the pressed state of the switch. It is possible that this first detection unit 500 may be provided on both the top surface of the main body unit 100 and the bottom surface of the cover unit 300. In addition, the first detection unit 500 may also use a touch-type detection sensor or a light-detection type sensor in addition to the switch-type detection sensor described above.

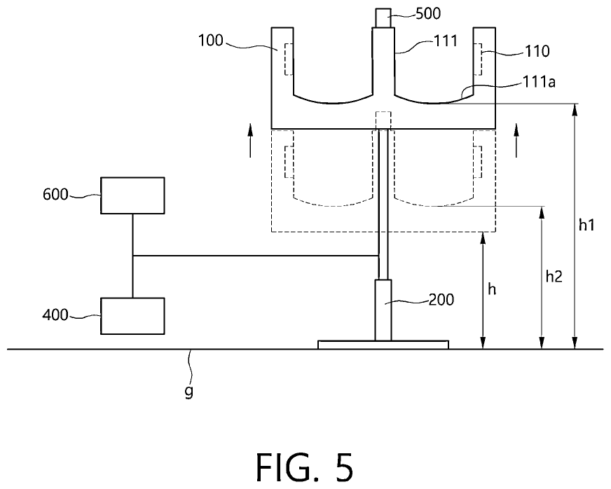

FIG. 5 is a front view showing a state in which the height of a main body unit is adjusted in a state in which a cover unit of an ottoman having a massaging apparatus according to an embodiment of the present invention is separated.

As shown in FIGS. 2 and 5, an outer support surface 310 spaced apart from the ground g by a first height h1 to support a part of the user's physical body may be provided on the top surface of the cover unit 300; the main body unit 100 may be provided with an accommodating groove 111 into which a part of the user's physical body is inserted and which is provided with an inner support surface 111a spaced apart from the ground g by a second height h2; and the control unit 400 may control the operation of the support unit 200 so that the inner support surface 111a moves up to the first height h1 when a separation signal of the cover unit 300 is input from the first detection unit 500.

That is, an outer support surface 310 is formed on the top surface of the cover unit 300 to support a part of the user's physical body, and the user can use this outer support surface 310 as an ottoman. In this case, the outer support surface 310 is spaced apart from the ground g by a first height h1 so that a part of physical body such as the legs or feet of a user sitting on a chair, etc. can be comfortably placed on it. This first height h1 may be set differently depending on the user's physical condition, and the user may input the desired first height h1 using an input unit 600.

In addition, an accommodating groove 111 is formed in the main body unit 100 into which a part of the user's physical body is inserted and placed, and the user can receive a massage through the operation of the massage member 110 with a part of the physical body, such as a leg or foot being inserted into the accommodating groove 111. In this case, an inner support surface 111a is formed in this accommodating groove 111 to support the inserted part of the user's physical body, and the inner support surface 111a is disposed at a position spaced apart from the ground g by a second height h2.

In addition, when the user places a part of the physical body on the outer support surface 310 and uses it as an ottoman and then separates the cover unit 300 for massage, a separation signal of the cover unit 300 is input to the control unit 400 through the first detection unit 500, and in this case, the control unit 400 controls the operation of the support unit 200 so that the inner support surface 111a disposed at the second height h2 moves to the first height h1.

That is, when the height of the inner support surface 111a is moved upward to the height of the outer support surface 310, the height remains the same when using as an ottoman and when using the massage member 110, thereby eliminating discomfort that the user may feel due to the height difference.

In addition, when a separation signal of the cover unit 300 is generated through the first detection unit 500 while the user separates the cover unit 300 to use the massage member 110, this separation signal is input to the control unit 400, the control unit 400 automatically moves the height of the inner support surface 111a upward, thereby improving user convenience.

In addition, after using the massage member 110, the user reinstalls the cover unit 300 to use it as an ottoman or when all uses have been completed, and in this case, whether the cover unit 300 is mounted may be detected through the first detection unit 500, and when the mounting signal of the cover unit 300 is input to the control unit 400, the user may control the height h of the main body unit 100 to be lowered again.

In this case, an input unit 600 for inputting the first height h1 or the second height h2 desired by the user may be further included, and the control unit 400 may control the operation of the support unit 200 to correspond to the first height h1 or the second height h2 input through the input unit 600. In other words, the comfortable height varies depending on the user's physical condition, so when the user inputs a height through the input unit 600, the control unit 400 controls the operation of the support unit 200 according to the input height. The control unit 400 may include a storage member such as a memory that stores height values such as the first height h1 or the second height h2 input by the user through the input unit 600.

Alternatively, the control unit 400 may control the operation of the massage member 110 or the support unit 200 according to a signal input through the input unit 600. The signal input through the input unit 600 may be transmitted to the control unit 400 through a wired method such as a communication cable, or may be transmitted to the control unit 400 through a signal transmission method such as infrared (IR) or Bluetooth. In addition, as described later, when a support module 800 is used to support other physical body parts of the user, it is also possible to configure the signal input through the input unit provided in the support module 800 to be transmitted to the control unit 400 using the signal transmission method described above.

In this case, the control unit 400 may control the massage member 110 to operate if a separation signal of the cover unit 300 is input from the first detection unit 500. With this configuration, it is possible to prevent the massage member 110 from operating arbitrarily while the user is using as ottoman, and the massage member 110 operates only when the cover unit 300 is separated to use the massage member 110, thereby ensuring the user's safety.

That is, as described above, when the massage function is used to massage a part of the physical body by separating the cover unit 300, it is configured so that the height of the main body unit 100 is automatically adjusted and the user can input the height of the main body unit 100, thereby improving user convenience.

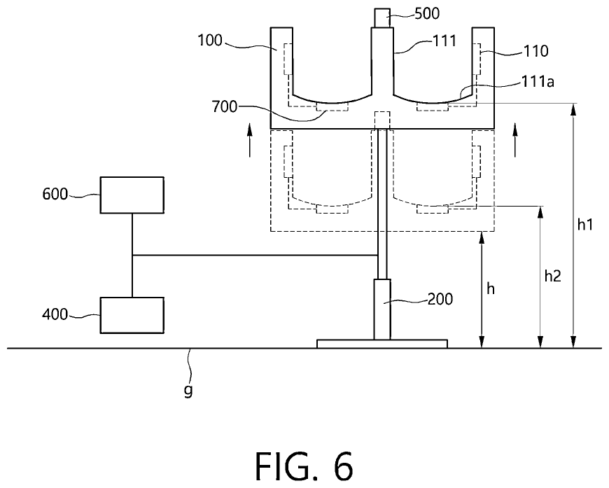

FIG. 6 is a front view showing a state in which the height of a main body unit is adjusted in a state in which a cover unit of an ottoman having a massaging apparatus according to another embodiment of the present invention is separated.

As shown in FIG. 6, a second detection unit 700 that detects that a part of the user's physical body is inserted into the main body unit 100 may be further included. That is, the second detection unit 700 is configured such that it detects that the user accurately inserts a physical body part into the accommodating groove 111 formed in the main body unit 100 to use the massage member 110, and only in this case, allows the massage member 110 to operate, thereby preventing malfunction and ensuring user safety.

In this case, an outer support surface 310 spaced apart from the ground g by a first height h1 to support a part of the user's physical body may be provided on the top surface of the cover unit 300; the main body unit 100 may be provided with an accommodating groove 111 into which a part of the user's physical body is inserted and which is provided with an inner support surface 111a spaced apart from the ground by a second height h2; and when a signal that a part of the user's physical body is inserted is input from the second detection unit 700 the control unit 400 may control the operation of the support unit 200 so that the inner support surface 111a moves up to the first height h1.

As described above, an outer support surface 310 is formed on the top surface of the cover unit 300 to support a part of the user's physical body, and the user can use this outer support surface 310 as an ottoman. In addition, an accommodating groove 111 is formed in the main body unit 100 into which a part of the user's physical body is inserted and placed, and the user can receive a massage through the operation of the massage member 110 with a part of the physical body, such as a leg or foot being inserted into the accommodating groove 111. When the user places a part of the physical body on the outer support surface 310 and uses it as an ottoman and then separates the cover unit 300 for massage and insert a part of the physical body into the accommodating groove 111, a signal that the part of the physical body is inserted is input to the control unit 400 through the second detection unit 700, and in this case, the control unit 400 controls the operation of the support unit 200 so that the inner support surface 111a disposed at the second height h2 moves to the first height h1.

As such, when the height of the inner support surface 111a is moved upward to the height of the outer support surface 310, the height remains the same when using as an ottoman and when using the massage member 110, thereby eliminating discomfort that the user may feel due to the height difference, and when the second detection unit 700 detects that a part of the physical body is completely inserted into the accommodating groove 111 after the user separates the cover unit 300 to use the massage member 110, this signal is input to the control unit 400 to automatically move the height of the inner support surface 111a upward, thereby improving user convenience.

In addition, when the user withdraws a physical body part from the accommodating groove 111 after using the massage member 110, whether the user's physical body part has been withdrawn is detected through the second detection unit 700, and the control unit 400 may receive this withdrawal signal from the second detection unit 700 and control the height h of the main body unit 100 to be lowered again for use as an ottoman or for termination of use.

In this case, it may be configured such that the second detection unit 700 detects the pressure applied by the massage member 110 to a part of the user's physical body, and the control unit 400 controls the operation of the support unit 200 when a pressure signal that a part of the user's physical body is pressurized is input from the second detection unit 700. That is, it is configured to automatically adjust the height depending on the intensity with which a part of the user's physical body is pressed through the massage member 110.

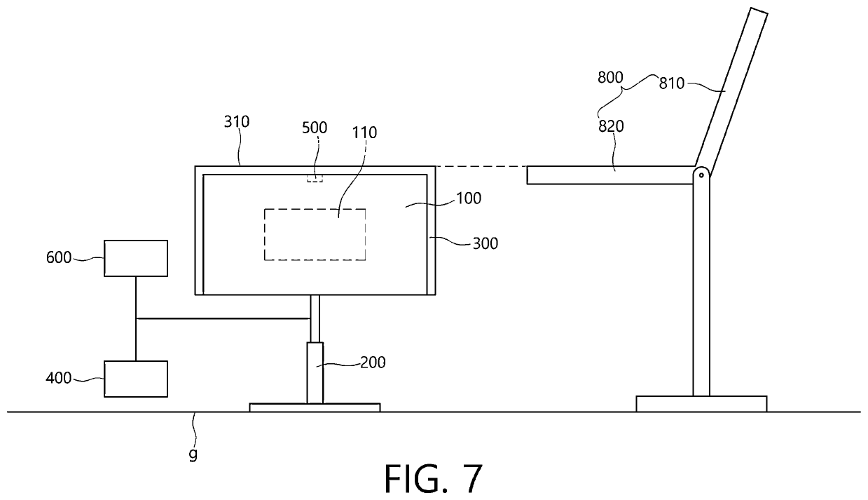

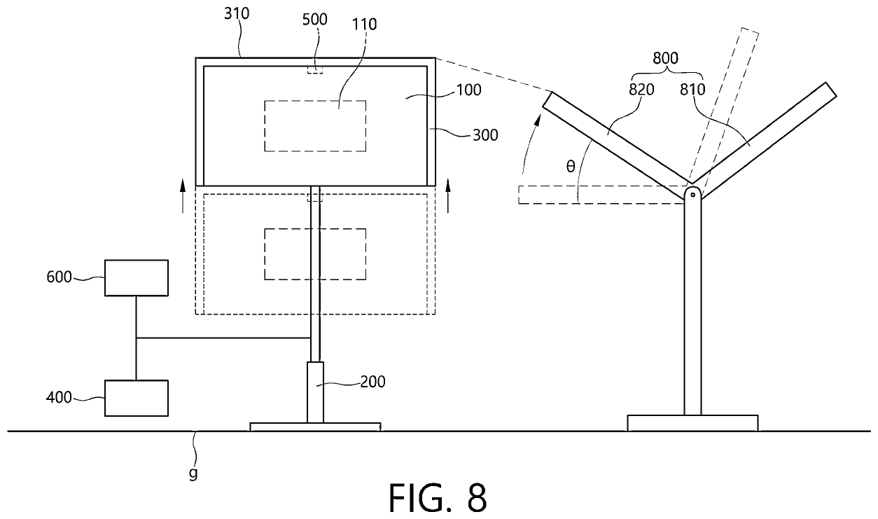

FIGS. 7 and 8 are side views showing a state in which an ottoman having a massaging apparatus according to an embodiment of the present invention is used with a support module for supporting other parts of the user's physical body, and are side views showing a state in which the height of the main body unit is adjusted in linkage according to the arrangement of the support module.

As shown in FIGS. 7 and 8, the control unit 400 may be configured to control the operation of the support unit 200 when a signal is input from the support module 800 that supports another physical body part of the user. As described above, the user sits on furniture such as a chair and uses the ottoman function or the massage function, and in this way, a signal input from the support module 800, such as a chair that supports other physical body parts such as the user's upper body or buttocks, is transmitted to the control unit 400 to control the support unit 200 to operate.

This support module 800 may include an upper plate member 810 that supports the user's upper body and a lower plate member 820 that supports the user's buttocks, and the control unit 400 may be configured to control the operation of the support unit 200 when a tilt angle (0) signal of the lower plate member 820 that is provided in the support module 800 and supports the user's buttocks is input.

That is, as shown in FIG. 8, if there is a reclining function that allows the user's upper body to lean by tilting the support module 800 within a certain angle range, as the user's upper body and buttocks move upward at a certain angle, the user's legs, etc., also move together, and in this way, the operation of the support unit 200 is controlled so that the main body unit 100 moves upward according to the tilt angle θ.

In this case, the control unit 400 may control the operation of the support unit 200 so that the separation height h of the main body unit 100 increases when the tilt angle θ of the lower plate member 820 increases, and may control the operation of the support unit 200 so that the separation height h of the main body unit 100 decreases when the tilt angle θ of the lower plate member 820 decreases.

That is, as described above, as the tilt angle θ of the lower plate member 820 increases, the support unit 200 is operated to increase the separation height h of the main body unit 100 so that the user does not experience discomfort when the user's upper body, buttocks, and legs move upward, and on the contrary, as the tilt angle θ of the lower plate member 820 decreases, the support unit 200 is operated to decrease the separation height h of the main body unit 100 when the user's upper body, buttocks, and legs move downward.

As such, the height h of the main body unit 100 is automatically adjusted in linkage with the support module 800 that supports other physical body parts of the user, thereby improving user convenience.

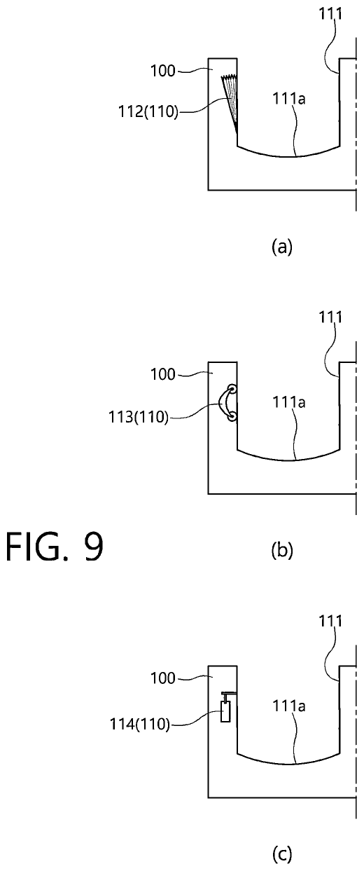

FIG. 9 is a cross-sectional view showing a massage member according to various embodiments of the present invention.

That is, as shown in (a) of FIG. 9, a massage member 110 having an air pocket 112 that pressurizes a part of the user's physical body using air pressure may be used, or as shown in (b) of FIG. 9, a massage member 110 having a pressure roller 113 that applies acupressure to a part of the user's physical body may be used, or as shown in (c) of FIG. 9, a massage member 110 having a vibrator 114 that applies vibration to a part of the user's physical body may be used, but it is not necessarily limited to these types of massage members 110, and any type of massage member can be used as long as it is configured to massage a part of the user's physical body. Such a massage member 110 may be placed in at least one position among the left, right, and bottom sides of the user's physical body part.

As described above, in the ottoman having a massaging apparatus according to the present invention, the massage member 110 is provided in the main body unit 100 to massage parts of the user's physical body, and the support unit 200 is configured to adjust the height h of the main body unit 100, so that user convenience is improved by adjusting the height h of the main body unit 100 according to the usage condition, and in particular, the cover unit 300 is provided on the upper portion of the main body unit 100, so it can be used as an ottoman on which a part of the user's physical body can be placed, and the control unit 400 is provided to automatically control the operations of the main body unit 100 and the support unit 200, thereby improving user convenience.

Although embodiments of the present invention have been described, the idea of the present invention is not limited to the embodiments set forth herein. Those of ordinary skill in the art who understand the idea of the present invention may easily propose other embodiments through supplement, change, removal, addition, etc. of elements within the scope of the same idea, but the embodiments will be also within the idea scope of the present invention.

1. A ottoman having a massaging apparatus, comprising:
a main body unit having a massage member that massages a part of a physical body of a user;
a support unit provided on the bottom surface of the main body unit to adjust a height of the main body unit away from the ground;
a cover unit surrounding the top surface of the main body unit; and
a control unit configured to control the operations of the main body unit and the support unit.

2. The ottoman having a massaging apparatus of claim 1, further comprising a first detection unit that is configured to detect that the cover unit is separated from the main body unit.

3. The ottoman having a massaging apparatus of claim 2, wherein the first detection unit is disposed on at least one of the top surface of the main body unit or the bottom surface of the cover unit.

4. The ottoman having a massaging apparatus of claim 2, wherein:
an outer support surface spaced apart from the ground by a first height to support a part of the user's physical body is provided on the top surface of the cover unit,
the main body unit is provided with an accommodating groove into which a part of the user's physical body is inserted and which is provided with an inner support surface spaced apart from the ground by a second height, and
the control unit is configured to control the operation of the support unit so that the inner support surface moves up to the first height when a separation signal of the cover unit is input from the first detection unit.

5. The ottoman having a massaging apparatus of claim 4,
further comprising an input unit configured to input the first height or the second height desired by the user,
wherein the control unit is configured to control the operation of the support unit to correspond to the first height or the second height input through the input unit.

6. The ottoman having a massaging apparatus of claim 5, wherein the control unit is provided with a storage member that stores a height value input through the input unit.

7. The ottoman having a massaging apparatus of claim 5, wherein the control unit is configured to control the operation of the massage member or the support unit according to a signal input through the input unit.

8. The ottoman having a massaging apparatus of claim 2, wherein the control unit is configured to control the operation of the massage member when a separation signal of the cover unit is input from the first detection unit.

9. The ottoman having a massaging apparatus of claim 1, further comprising a second detection unit that is configured to detect that a part of the user's physical body is inserted into the main body unit.

10. The ottoman having a massaging apparatus of claim 9, wherein:
an outer support surface spaced apart from the ground by a first height to support a part of the user's physical body is provided on the top surface of the cover unit,
the main body unit is provided with an accommodating groove into which a part of the user's physical body is inserted and which is provided with an inner support surface spaced apart from the ground by a second height, and
the control unit is configured to the operation of the support unit so that the inner support surface moves up to the first height when a signal that a part of the user's physical body is inserted is input from the second detection unit.

11. The ottoman having a massaging apparatus of claim 9, wherein:
the second detection unit is configured to detect pressure applied by the massage member to a part of the user's physical body, and
the control unit is configured to control the operation of the support unit when a pressure signal that a part of the user's physical body is pressurized is input from the second detection unit.

12. The ottoman having a massaging apparatus of claim 1, wherein the control unit is configured to control the operation of the support unit when a signal is input from a support module that supports another physical body part of the user.

13. The ottoman having a massaging apparatus of claim 12, wherein the control unit is configured to control the operation of the support unit when a tilt angle signal of a lower plate member that is provided in the support module and supports the user's buttocks is input.

14. The ottoman having a massaging apparatus of claim 13, wherein the control unit is configured to control the operation of the support unit so that a separation height of the main body unit increases when the tilt angle of the lower plate member increases, and control the operation of the support unit so that the separation height of the main body unit decreases when the tilt angle of the lower plate member decreases.

15. The ottoman having a massaging apparatus of claim 1, wherein the massage member is one of an air pocket that pressurizes a part of the user's physical body using air pressure, a pressure roller that is configured to apply acupressure to a part of the user's physical body, and a vibrator that is configured to apply vibration to a part of the user's physical body.

16. The ottoman having a massaging apparatus of claim 1, wherein:
a height lever is provided on one side of the main body unit to manually adjust the height at which the main body unit is separated from the ground, and
a tilting lever is provided on the other side of the main body unit to manually adjust the tilt angle of the main body unit so that the main body unit is disposed at an angle to the ground.
